(19) United States
(12) Patent Application Publication
(10) Pub. No.: US 2024/0309130 A1
(43) Pub. Date: Sep. 19, 2024

(54) COMPOSITION BASED ON (METH)ACRYLATE MONOMERS

(71) Applicants: Bostik SA, COLOMBES (FR); Universite De Haute-Alsace, MULHOUSE CEDEX (FR); Centre National De La Recherche Scientifique, PARIS (FR)

(72) Inventors: Jérôme MAZAJCZYK, VENETTE (FR); Stéphane FOUQUAY, Mont Saint Aignan (FR); Frédéric SIMON, VENETTE (FR); Guillaume MICHAUD, LYON (FR); Alexis BARRAT, VENETTE (FR); Jacques LALEVEE, MULHOUSE (FR)

(21) Appl. No.: 18/576,224

(22) PCT Filed: Jul. 11, 2022
(86) PCT No.: PCT/FR2022/051392

§ 371 Date: Jan. 3, 2024

(30) Foreign Application Priority Data
Jul. 12, 2021 (FR) FR2107545

(51) Int. Cl. C08F 120/28; C08F 2/50; C08K 5/095; C08K 5/3432; C09D 7/63; C09D 133/14; C09J 11/06; C09J 133/14

(52) U.S. Cl. CPC C08F 120/28; C08F 2/50; C08K 5/095; C08K 5/3432; C09D 7/63; C09D 133/14; C09J 11/06; C09J 133/14; C08K 2201/019; C09J 2433/00

(57) ABSTRACT

The present invention relates to a crosslinkable two-component composition comprising:
a component A comprising:
   an iodonium salt having one of the formulae (I-A), (I-B) or (I-C);
   at least one (meth)acrylate monomer M1;
   an organic or mineral acid having a pka or pka1 ranging from 0.3 to 5 measured in water at 25° C.;
   at least one photoinitiator P1;
a component B comprising at least one dihydropyridine compound having one of the formulae (III) to (VI);

said composition not comprising any peroxide.

### FIELD OF THE INVENTION

The present invention relates to a composition based on (meth)acrylate monomer.

The invention also relates to the use of said composition in the repair and/or the semi-structural or structural adhesive bonding of materials in the transportation, marine, assembly, electronics or construction field.

### TECHNOLOGICAL BACKGROUND

Acrylic compositions are known reactive systems which crosslink by radical polymerization. They are used as adhesives, mastics and coatings. Radical polymerization is typically initiated by a redox system which, by means of an oxidation-reduction reaction, results in the production of radicals.

Most acrylic systems are two-component systems. The first component conventionally contains the reducing agent and the reactive monomers, and the second component contains the oxidizing agent. Once the two components have been mixed, the reducing agent induces cleavage of the O—O bond of the organic peroxide for example, and initiates polymerization.

Typically, (meth)acrylic compositions comprise a peroxide (oxidizing agent)/tertiary amine (reducing agent) redox system. However, these systems may present storage stability problems in the presence of (meth)acrylate monomer.

There is a need for novel (meth)acrylic compositions which allow a good compromise between reactivity and storage stability.

In addition, there is also a need for novel (meth)acrylic compositions with good adhesive properties.

### DESCRIPTION OF THE INVENTION

The present invention relates to a crosslinkable two-component composition comprising:
a component A comprising:
   an iodonium salt having one of the formulae (I-A), (I-B) or (I-C) below:

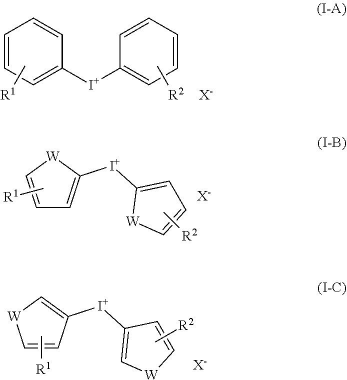

in which:
   R¹ and R² each represent, independently of each other, a hydrogen atom, an alkyl radical, an alkenyl radical, a cycloalkyl radical, a cycloalkenyl radical, an aryl radical, a chlorine atom, a bromine atom, an iodine atom, a carboxylic radical, or an —NO₂ radical;
   X-represents a monovalent anion;
   W represents O or S;
at least one (meth)acrylate monomer M1;
an organic or mineral acid having a pKa or pKa1 ranging from 0.3 to 5.0 measured in water at 25° C.;
at least one photoinitiator P1;
   a component B comprising at least one dihydropyridine compound having one of the formulae (III) to (VII) below:

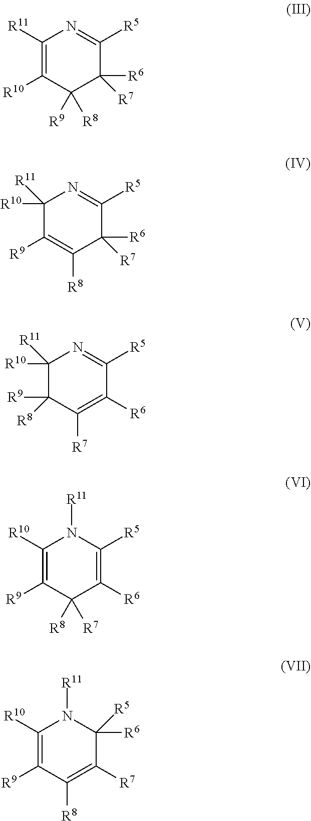

in which:
   each of the radicals R⁵ to R¹¹ represents, independently of each other, a hydrogen, an alkyl, an alkenyl, an alkynyl, a cycloalkyl, a heterocycloalkyl, a heteroaryl, an aryl, an alkylaryl, an arylalkyl, a radical —COOR^{a};
   said alkyl, alkenyl, alkynyl, cycloalkyl, heterocycloalkyl, heteroalkyl, aryl, alkylaryl and arylalkyl groups being optionally substituted; and R^{a} represents an alkyl or aryl radical;
   or two radicals from among R⁵ to R¹¹ together form an optionally substituted monocyclic or polycyclic ring;
      said crosslinkable two-component composition not comprising any peroxide.

In the context of the invention, the term “alkyl” means a linear or branched radical preferably comprising from 1 to 20 carbon atoms. Mention may be made, for example, of methyl, ethyl and propyl.

In the context of the invention, the term “alkenyl” means a linear or branched hydrocarbon-based radical including at least one double bond, said radical preferably comprising from 2 to 20 carbon atoms. Examples that may be mentioned include propenyl and butenyl.

In the context of the invention, the term “alkynyl” means a linear or branched hydrocarbon-based radical including at least one triple bond, said radical preferably comprising from 2 to 20 carbon atoms.

In the context of the invention, the term “aryl” means a monocyclic or bicyclic aromatic radical preferably comprising from 6 to 12 carbon atoms. Mention may be made, for example, of phenyl.

In the context of the invention, the term “arylalkyl” means an alkyl group substituted with an aryl group, the arylalkyl group preferably comprising from 7 to 20 carbon atoms. As an arylalkyl group, mention may be made, for example, of benzyl.

In the context of the invention, the term “alkylaryl” means an aryl group substituted with an alkyl group, said alkylaryl group preferably comprising from 7 to 20 carbon atoms.

In the context of the invention, the term “heteroaryl” means a monocyclic or bicyclic aromatic radical comprising at least one heteroatom, for instance O, S or N, and preferably comprising from 4 to 12 carbon atoms. Examples that may be mentioned include furanyl, thiophenyl, pyrrolyl, pyridinyl, indolyl or imidazolyl radicals.

In the context of the invention, the term “cycloalkyl” means a monocyclic or polycyclic, preferably monocyclic or bicyclic, saturated system preferably including from 3 to 12 carbon atoms, the rings possibly being bridged or fused in pairs, such as cyclopropyl, cyclopentyl, cyclohexyl or norbornyl groups.

In the context of the invention, the term “heterocycloalkyl” means a monocyclic or polycyclic, preferably monocyclic or bicyclic, saturated system, preferably including from 3 to 12 carbon atoms and at least one heteroatom, for instance O or N, the rings possibly being fused or bridged in pairs.

In the context of the invention, the term “cycloalkenyl” means a monocyclic or polycyclic system comprising at least one double bond, preferably including from 3 to 12 carbon atoms, the rings possibly being fused or bridged in pairs.

In the context of the invention, the term “alkoxy” means an —O-alkyl radical.

### Component A

### Iodonium Salt of Formula (I-A), (I-B) or (I-C)

Component A comprises an iodonium salt having one of the formulae (I-A), (I-B) or (I-C) as defined above.

Preferably, in the abovementioned formulae (I-A), (I-B) and (I-C), R¹ and R² each represent, independently of each other, an alkyl radical or a hydrogen atom.

In the abovementioned formulae (I-A), (I-B) and (I-C), X may represent F⁻, Cl⁻, Br⁻, I⁻, NO₃⁻, HSO₄⁻, H₂PO₄⁻, HCOO⁻, CH₃COO⁻, BF₄⁻, AsF₆⁻, PF₆⁻, CH₃—Ph—SO₃⁻, (F₅Ph)₄B⁻ or SbF₆⁻. Preferably, in the abovementioned formulae (I-A), (I-B) and (I-C), X represents BF₄⁻, PF₆⁻, CH₃—Ph—SO₃⁻, (F₅Ph)₄B⁻ or SbF₆⁻. Even more preferentially, X represents the anion (F₅Ph)₄B⁻ of the following formula:

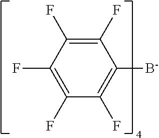

Among the iodonium salts of formula (I-B), mention may be made, for example, of:

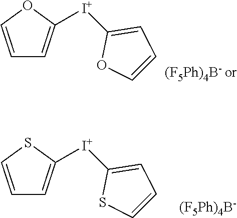 [SMILES: c1coc([I+]c2ccco2)c1 ; c1csc([I+]c2cccs2)c1]

Among the iodonium salts of formula (I-C), mention may be made, for example, of:

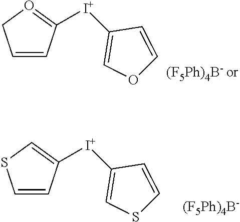

Among the iodonium salts of formula (I-A), mention may be made, for example, of diphenyliodonium hexafluorophosphate, diphenyliodonium fluoroborate, diphenyliodonium 2-carboxylate, bis(4-tert-butylphenyl)iodonium hexafluorophosphate, 3,3′-dimethyldiphenyliodonium hexafluorophosphate and (4-isopropylphenyl)(4-methylphenyl)iodonium tetrakis(pentafluorophenyl)borate.

Preferably, the iodonium salt is a salt of formula (I-A). Even more preferably, the iodonium salt is (4-isopropylphenyl)(4-methylphenyl)iodonium tetrakis(pentafluorophenyl)borate having the following formula:

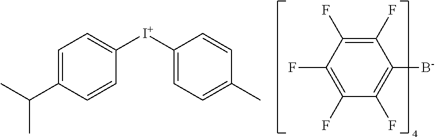

The iodonium salts of formula (I-A) may be prepared as described in U.S. Pat. No. 4,151,175 or U.S. Pat. No. 4,238,394. The iodonium salts of formula (I-B) may be prepared as described in Journal of Fluorine Chemistry (2009), 130(5), 501-504. The iodonium salts of formula (I-C) may be prepared as described in Journal of Heterocyclic Chemistry (1977), 14(2), 281-8.

The total content of iodonium salt of formula (I-A), (I-B) or (I-C) may range from 0.20% to 5.0% by weight, preferably from 0.50% to 3.0% by weight, even more preferentially from 0.50% to 1.5% by weight relative to the total weight of the crosslinkable two-component composition.

### (Meth)acrylate Monomer M1

The two-component composition according to the invention comprises at least one (meth)acrylate monomer M1.

The (meth)acrylate monomer may comprise one (meth)acrylate function (monofunctional) or several (meth)acrylate functions (polyfunctional).

The (meth)acrylate monomer M1 may have the formula (II) below:

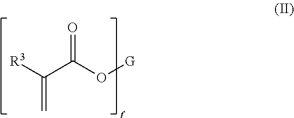

in which R³ represents H or methyl, G represents an organic radical preferably comprising at least one oxygen atom, and f represents an integer from 1 to 4.

In the abovementioned formula (II), G may represent a radical chosen from the group consisting of alkyls, cycloalkyls, alkenyls, cycloalkenyls, alkylaryls, arylalkyls or aryls, said alkyls, cycloalkyls, alkenyls, cycloalkenyls, alkylaryls, arylalkyls or aryls being optionally substituted with and/or interrupted with at least one silane, silicone, oxygen, halogen, carbonyl, hydroxyl, ester, urea, urethane, carbonate, amine, amide, sulfur, sulfonate or sulfone.

In the abovementioned formula (II), f may represent 1, 2, 3 or 4, f preferably representing 1.

The (meth)acrylate monomer(s) M1 may be chosen from the group consisting of:
compounds having the formula (II-1) below:

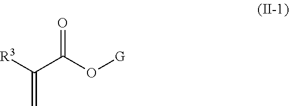

in which:
R³ represents H or methyl;
G is chosen from the group consisting of alkyls, cycloalkyls, alkenyls, cycloalkenyls, alkylaryls, arylalkyls or aryls, said alkyls, cycloalkyls, alkenyls, cycloalkenyls, alkylaryls, arylalkyls or aryls possibly being optionally substituted with and/or interrupted with at least one silane, silicone, oxygen, halogen, carbonyl, hydroxyl, ester, urea, urethane, carbonate, amine, amide, sulfur, sulfonate or sulfone;
polyethylene glycol di(meth)acrylates;
hexanediol di(meth)acrylate;
trimethylolpropane tri(meth)acrylate;
diethylene glycol di(meth)acrylate;
triethylene glycol di(meth)acrylate;
tetraethylene glycol di(meth)acrylate;
dipropylene glycol di(meth)acrylate;
di(pentamethylene glycol) di(meth)acrylate;
diglycerol tetra(meth)acrylate;
tetramethylene di(meth)acrylate;
ethylene di(meth)acrylate;
bisphenol A mono- and di(meth)acrylates;
bisphenol F mono- and di(meth)acrylates;
compounds of formula (VIII), (IX) or (X) below

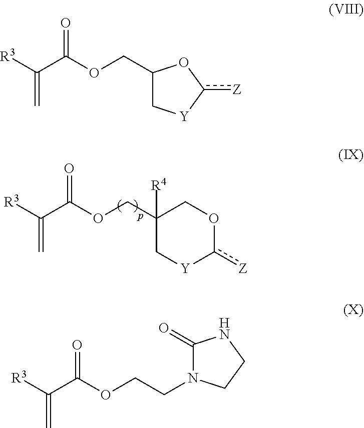

in which:
R³ represents H or methyl;
R⁴ represents H, methyl or ethyl;
p represents 0 or 1; and
Z represents H, O, S, an alkyl group, a benzyl group, an aryl group or an alkoxy group;
Y represents O, S, NH or CH₂;
[symbol] is a single bond or a double bond,
on condition that when Z represents O, then the bond [symbol] is a double bond;
   and mixtures thereof.

Among the monomers M1 of formula (II-1), mention may be made, for example, of methyl (meth)acrylate, ethyl (meth)acrylate, 2-ethylhexyl (meth)acrylate, n-butyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, 3-vinylcyclohexyl (meth)acrylate, bornyl (meth)acrylate, 2,4,5-tri-t-butyl-3-vinylcyclohexyl (meth)acrylate, 2,3,4,5-tetra-t-butylcyclohexyl (meth)acrylate; benzyl (meth)acrylate, phenyl (meth)acrylate, 2-(2-ethoxyethoxy)ethyl (meth)acrylate, 2-phenoxyethyl (meth)acrylate, and mixtures thereof.

Among the abovementioned monomers M1 of formula (VIII), examples that may be mentioned include:

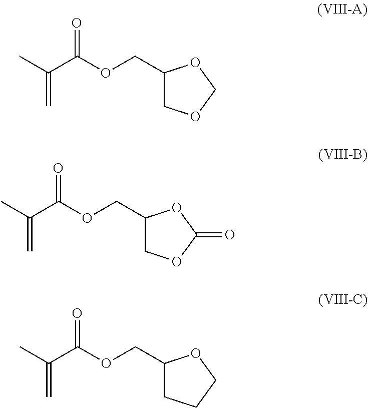

Among the abovementioned monomers M1 of formula (IX), examples that may be mentioned include:

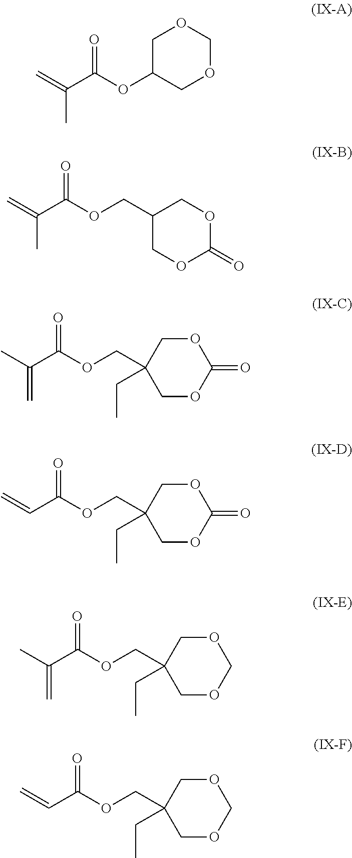

The radical G may be an organic radical comprising at least one oxygen atom.

According to a preferred embodiment, G is an organic radical comprising at least one oxygen atom, said radical G being a polar aprotic radical.

In the context of the invention, and unless otherwise mentioned, the term “aprotic radical” means a radical not comprising any acidic hydrogens.

In the context of the invention, and unless otherwise mentioned, the term “polar radical” means a radical containing polar bonds in which the sum of all the dipole moments of the bond is non-zero.

The monomer M1 is preferably chosen from the monomers of formula (VIII) or (IX). It is even more preferentially one of the following compounds or mixtures thereof:

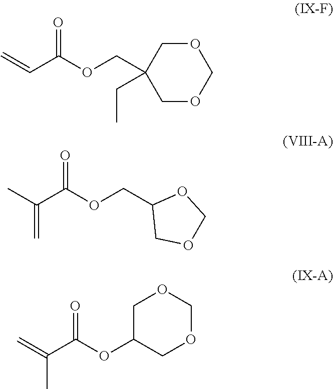

The total content of (meth)acrylate monomer(s) M1 in component A may be greater than or equal to 30% by weight relative to the total weight of said component A.

The content of (meth)acrylate monomer(s) M1 in the crosslinkable two-component composition according to the invention may range from 30% to 99% by weight, preferably from 50% to 99% by weight and even more preferentially from 75% to 99% by weight relative to the total weight of said crosslinkable two-component composition.

### Organic or Mineral Acid

Component A comprises an organic or mineral acid having a pKa or pKa1 ranging from 0.3 to 5 measured in water at 25° C.

The pKa (or acidity constant) is defined by pKa=−log₁₀ Ka, where Ka is the acid dissociation constant which is measured in the standard manner at 25° C. The recommended standard measurement method for pKa is notably potentiometry, and more precisely pH-metry, as described, for example, in Techniques de l'ingénieur [Engineering Techniques] (ref. K695 v1). This is the method most commonly used for determining pKa.

The pka1 is defined by pKa1=−log₁₀ Ka1, where Ka1 is the acid dissociation constant of the first strongest acidity of the polyacids. Ka2 is the acid dissociation constant of the second acidity of the polyacids (where appropriate) and Ka3 is the acid dissociation constant of the third weakest acidity of the polyacids (where appropriate). Each successive acidity of a polyacid pKa1, pKa2 or pKa3 corresponds notably to decreasing values of the acidity constants Ka1, Ka2 and Ka3. The same standard potentiometric measurement indicated previously is used to measure them.

Among the organic acids, mention may be made, for example, of carboxylic acids, phosphorus-based acids and mixtures thereof.

Among the carboxylic acids, mention may be made, for example, of formic acid, acetic acid, monochloroacetic acid, monofluoroacetic acid, dichloroacetic acid, difluoroacetic acid, propionic acid, malic acid, fumaric acid, malonic acid, succinic acid, maleic acid, fumaric acid, citric acid, acrylic acid, methacrylic acid, cyanoacetic acid, salicylic acid, itaconic acid, benzoic acid, glycolic acid, thioglycolic acid, pyruvic acid, cinnamic acid, and mixtures thereof.

Among the mineral acids, mention may be made, for example, of phosphoric acid, phosphorous acid, methylphosphonic acid, hypophosphorous acid and mixtures thereof.

According to one embodiment, the acid has a pka or pka1 ranging from 2 to 5, and notably from 4 to 5.

According to a preferred embodiment, the acid having a pKa or pka1 ranging from 0.3 to 5 is an organic acid chosen from carboxylic acids, and even more preferentially chosen from acrylic acid, methacrylic acid, itaconic acid, salicylic acid, benzoic acid, monochloroacetic acid, monofluoroacetic acid, dichloroacetic acid, difluoroacetic acid and mixtures thereof. Even more preferably, it is dichloroacetic acid or difluoroacetic acid.

The presence of this (these) acid(s) advantageously allows activation of the dihydropyridine compound of formulae (III) to (VII).

The total content of acid(s) having a pka or pka1 ranging from 0.3 to 5 may range from 0.1% to 20% by weight, preferably from 0.1% to 10% by weight, more preferably from 0.2% to 5%, and even more preferentially from 0.2% to 2% by weight relative to the total weight of the crosslinkable two-component composition according to the invention.

### Photoinitiator P1

Component A comprises at least one photoinitiator P1.

This photoinitiator P1 is different from the iodonium salt of formula (I-A), (I-B) or (I-C) as defined previously.

The photoinitiator may be any photoinitiator known to those skilled in the art. Under the action of UV/visible radiation, the photoinitiator typically generates radicals which will be responsible for the initiation of the photopolymerization reaction, and makes it possible in particular to increase the efficiency of the photopolymerization reaction. This is, of course, chosen as a function of the light source used, according to its ability to efficiently absorb the radiation selected. It will be possible, for example, to choose the appropriate photoinitiator from its UV/visible absorption spectrum. Advantageously, the photoinitiator is appropriate for working with irradiation sources emitting in the near zone ranging from 300 to 420 nm. Advantageously, the source of UV or visible radiation may be an LED.

The photoinitiator P1 may be chosen from the group consisting of:
type I photoinitiators chosen from:
   the family of acetophenones and alkoxyacetophenones, for instance 2,2-dimethoxy-2-phenylacetophenone and 2-diethyl-2-phenylacetophenone;
   the family of hydroxyacetophenones, for instance 2,2-dimethyl-2-hydroxyacetophenone, 1-hydroxycyclohexyl phenyl ketone, 2-hydroxy-4′-(2-hydroxyethoxy)-2-methylpropiophenone and 2-hydroxy-4′-(2-hydroxypropoxy)-2-methylpropiophenone;
   the family of alkylaminoacetophenones, for instance 2-methyl-4′-(methylthio)-2-morpholinopropiophenone, 2-benzyl-2-(dimethylamino)-4-morpholinobutyrophenone and 2-(4-methylbenzyl)-2-(dimethylamino)-4-morpholinobutyrophenone;
   the family of benzoin ethers, for instance benzil, benzoin methyl ether and benzoin isopropyl ether;
   the family of phosphine oxides, for instance diphenyl(2,4,6-trimethylbenzoyl)phosphine oxide (TPO), ethyl(2,4,6-trimethylbenzoyl)phenylphosphine oxide (TPO-L) and bis(2,6-dimethoxybenzoyl)-2,4,4-trimethylphenylphosphine oxide (BAPO);
   the family of metallocenes, for instance ferrocene, bis(η5-2,4-cyclopentadien-1-yl)bis(2,6-difluoro)-3-(1H-pyrrol-1-yl)phenyl) titanium and (cumene)(cyclopentadienyl)iron hexafluorophosphate;
type II photoinitiators chosen from:
   the family of benzophenones, for instance 4-phenylbenzophenone, 4-(4′-methylphenylthio)benzophenone or 1-[4-[(4-benzoylphenyl)thio]phenyl]-2-methyl-2-[(4-methylphenyl)sulfonyl]-1-propanone;
   the family of thioxanthones, for instance isopropylthioxanthone (ITX), 2,4-diethylthioxanthone, 2,4-dimethylthioxanthone, 2-chlorothioxanthone and 1-chloro-4-isopropylthioxanthone;
   the family of benzoylformate esters, for instance methyl benzoylformate;
   the family of dibenzylidene ketones, for instance p-dimethylamino ketone;
   the family of coumarins, for instance 5-methoxy- and 7-methoxycoumarin, 7-diethylaminocoumarin and N-phenylglycine coumarin;
photoinitiators of the family of dyes, for instance triazines, fluorones, cyanines, safranins, 4,5,6,7-tetrachloro-3′,6′-dihydroxy-2′,4′,5′,7′-tetraiodo-3H-spiro[isobenzofuran-1,9′-xanthen]-3-one, pyryliums and thiopyryliums, thiazines, flavins, pyronines, oxazines or rhodamines;
and mixtures thereof.

According to a preferred embodiment, the photoinitiator P1 is chosen from:
the family of phosphine oxides, for instance diphenyl(2,4,6-trimethylbenzoyl)phosphine oxide (TPO), ethyl(2,4,6-trimethylbenzoyl)phenylphosphine oxide (TPO-L) and bis(2,6-dimethoxybenzoyl)-2,4,4-trimethylphenylphosphine oxide (BAPO);
the family of thioxanthones, for instance isopropylthioxanthone (ITX), 2,4-diethylthioxanthone, 2,4-dimethylthioxanthone, 2-chlorothioxanthone and 1-chloro-4-isopropylthioxanthone;
the photoinitiator P1 being even more preferentially chosen from diphenyl(2,4,6-trimethylbenzoyl)phosphine oxide (TPO), and ethyl(2,4,6-trimethylbenzoyl)phenylphosphine oxide (TPO-L).

The total content of photoinitiator(s) P1 may range from 0.1% to 5% by weight, preferably from 0.1% to 2%, and even more preferentially from 0.1% to 1% by weight relative to the total weight of the crosslinkable two-component composition according to the invention.

### Component B

### Dihydropyridine Compound of Formulae (III) to (VII)

Component B comprises at least one dihydropyridine compound having one of the formulae (III) to (VII) as defined above.

The dihydropyridine compound may be chosen from those of formulae (III) to (VII) in which:
R¹¹ represents an aryl or heteroaryl, said aryl or heteroaryl being optionally substituted, and
R⁵ to R¹⁰ represents, independently of each other, a hydrogen, an alkyl, an alkenyl, an alkynyl, a cycloalkyl, a heterocycloalkyl, a heteroaryl, an aryl, an alkylaryl, an arylalkyl, a radical —COOR^{a}, R^{a} representing an alkyl;
R⁵ to R¹⁰ preferably representing, independently of each other, a hydrogen or an alkyl or a radical—COOR^{a} with R^{a} representing an alkyl.

According to a preferred embodiment, the dihydropyridine compound has the formula (VI) or (VII) as defined previously.

The dihydropyridine compound may be chosen from the following compounds:

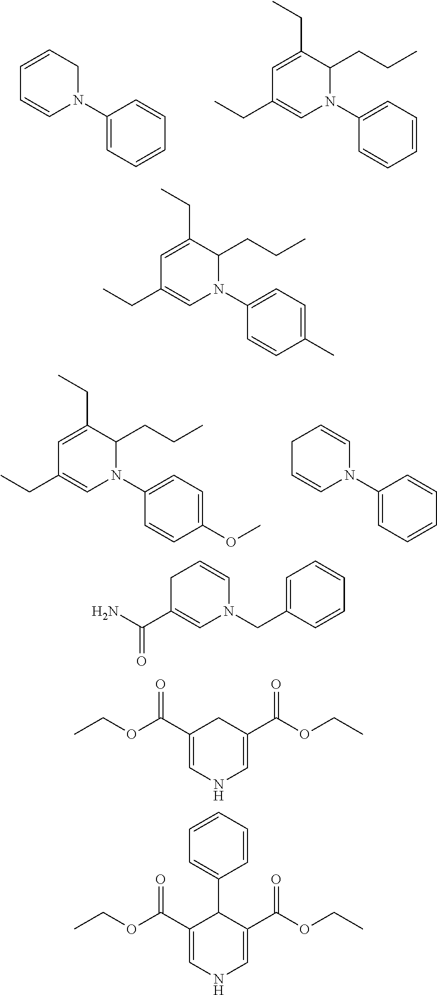

According to a preferred embodiment, the dihydropyridine is the following compound:

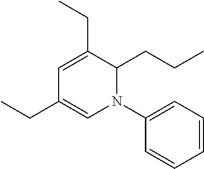 [SMILES: CCCC1C(CC)=CC(CC)=CN1c1ccccc1]

The dihydropyridines may be commercially available, for instance Vanax 808 HP sold by the company Vanderbilt Chemicals, or may be synthesized as described, for example, in WO 2006/086602.

The total content of dihydropyridine compound(s) having one of the formulae (III) to (VII) as defined previously may range from 0.2% to 5.0% by weight, preferably from 0.3% to 3.0% by weight, and even more preferentially from 0.4% to 1.5% by weight relative to the total weight of the crosslinkable two-component composition according to the invention.

In the crosslinkable two-component composition according to the invention, the mole ratio of dihydropyridine compound(s) of formulae (III) to (VII)/iodonium salt(s) of formula (I-A) or (I-B) or (I-C) may range from 0.70 to 9, preferably from 1 to 6, and even more preferentially from 1 to 3.

### Composition

The crosslinkable two-component composition according to the invention may comprise at least one additive chosen from the group consisting of catalysts, fillers, antioxidants, light stabilizers/UV absorbers, metal deactivators, antistatic agents, film-preventing agents, foaming agents, biocides, plasticizers, lubricants, emulsifiers, dyes, pigments, rheological agents, impact modifiers, adhesion promoters, accelerators, optical brighteners, flame retardants, anti-sweating agents, nucleating agents, solvents, and mixtures thereof.

These additives may be present in component A and/or component B of the composition according to the invention.

An example of an accelerator that may be mentioned is saccharin.

As examples of plasticizers that may be used, mention may be made of any plasticizer normally used in the field of adhesives, for instance epoxy resins, phthalates, benzoates, trimethylolpropane esters, trimethylolethane esters, trimethylolmethane esters, glycerol esters, pentaerythritol esters, naphthenic mineral oils, adipates, cyclohexyldicarboxylates, paraffinic oils, natural oils (optionally epoxidized), polypropylenes, polybutylenes, hydrogenated polyisoprenes, and mixtures thereof.

Use may be made, for example, of:
diisodecyl phthalate, as sold, for example, under the name Palatinol™ DIDP by the company BASF,
an ester of alkylsulfonic acid and of phenol, as sold, for example, under the name Mesamoll@ by the company Lanxess,
diisononyl 1,2-cyclohexanedicarboxylate, as sold, for example, under the name Hexamoll Dinch@ by the company BASF,
pentaerythrityl tetravalerate, as sold, for example, under the name Pevalen™ by the company Perstorp,
the epoxidized soya bean oil as sold, for example, under the name Vikoflex® 7170 by the company Arkema.

As examples of (thixotropic) rheological agent(s) that may be used, mention may be made of any rheological agent customarily used in the field of adhesive compositions.

Preferably, the thixotropic agents are chosen from:
PVC plastisols, corresponding to a suspension of PVC in a plasticizing agent which is miscible with PVC, obtained in situ by heating to temperatures ranging from 60° C. to 80° C. These plastisols may be those described in particular in the publication “Polyurethane Sealants”, Robert M. Evans, ISBN 087762-998-6,
fumed silica, as sold, for example, under the name HDK® N20 by Wacker;
urea derivatives resulting from the reaction of an aromatic diisocyanate monomer, such as 4,4′-MDI, with an aliphatic amine, such as butylamine. The preparation of such urea derivatives is described notably in patent application FR 1 591 172;
micronized amide waxes, such as Crayvallac® SLT or Crayvallac@ SLA sold by Arkema.

The composition according to the invention may also comprise at least one organic and/or mineral filler.

The mineral filler(s) that may be used are advantageously chosen so as to improve the mechanical performance of the composition according to the invention in the crosslinked state.

As examples of mineral filler(s) that may be used, use may be made of any mineral filler(s) usually used in the field of adhesive compositions. These fillers are typically in the form of particles of diverse geometry. They may be, for example, spherical or fibrous or may have an irregular shape.

Preferably, the filler(s) are chosen from the group consisting of clay, quartz, carbonate fillers, kaolin, gypsum, clays and mixtures thereof; preferentially, the filler(s) are chosen from carbonate fillers, such as alkali metal or alkaline-earth metal carbonates, and more preferentially calcium carbonate or chalk.

These fillers may be untreated or treated, for example using an organic acid, such as stearic acid, or a mixture of organic acids predominantly consisting of stearic acid.

Use may also be made of hollow mineral microspheres, such as hollow glass microspheres, and more particularly of those made of calcium sodium borosilicate or of aluminosilicate.

The composition according to the invention may also comprise at least one adhesion promoter, preferably chosen from silanes, such as aminosilanes, epoxysilanes or acryloyl silanes, or adhesion promoters based on a phosphate ester, for instance the 2-hydroxyethyl methacrylate phosphate ester, 2-methacryloyloxyethyl phosphate, bis(2-methacryloyloxyethyl phosphate), 2-acryloyloxyethyl phosphate, bis(2-acryloyloxyethyl phosphate), methyl(2-methacryloyloxyethyl phosphate), ethyl(2-methacryloyloxyethyl phosphate), a mixture of 2-hydroxyethyl methacrylate mono- and diphosphate esters.

When a pigment is present in the composition, its content is preferably less than or equal to 3% by weight, more preferably less than or equal to 2% by weight, relative to the total weight of the composition. When it is present, the pigment can, for example, represent from 0.1% to 3% by weight or from 0.4% to 2% by weight relative to the total weight of the composition.

The pigments may be organic or inorganic pigments.

For example, the pigment is TiO₂, in particular Kronos@ 2059 sold by the company Kronos.

The composition may comprise an amount of from 0.1% to 3%, preferably from 1% to 3%, by weight of at least one UV stabilizer or antioxidant. These compounds are typically introduced in order to protect the composition from degradation resulting from a reaction with oxygen which is liable to be formed by the action of heat or light. These compounds may include primary antioxidants which trap free radicals. The primary antioxidants can be used alone or in combination with other secondary antioxidants or UV stabilizers.

Mention may be made, for example, of Irganox@ 1010, Irganox@ B561, Irganox@ 245, Irgafos@ 168, Tinuvin@ 328 or Tinuvin™ 770, which are sold by BASF.

According to a preferred embodiment, the two-component composition according to the invention does not comprise any metal acetylacetonate, for instance iron acetylacetonate or copper acetylacetonate.

In the composition according to the invention, the component A/component B volume ratio may range from 20/1 to 1/1, preferentially from 10/1 to 1/1.

### B. Ready-to-Use Kit

The present invention also relates to a ready-to-use kit, comprising both component A as defined above and component B as defined above, packaged in two separate compartments. It may, for example, be a two-component cartridge.

Indeed, the composition according to the invention may be in a two-component form, for example in a ready-to-use kit, comprising both component A in a first compartment or drum and component B in a second compartment or drum, in proportions suitable for direct mixing of the two components, for example using a metering pump.

According to one embodiment of the invention, the kit also comprises one or more means for mixing components A and B. Preferably, the mixing means are chosen from metering pumps or static mixers with a diameter suited to the amounts used.

C. Uses of the Composition

The present invention also relates to the use of a crosslinkable two-component composition as defined above as adhesive, mastic or coating, preferably as adhesive.

The invention also relates to the use of said composition in the repair and/or the structural or semi-structural adhesive bonding of materials in the transportation, motor vehicle (car, bus or truck), assembly, marine, electronics or construction field.

The present invention relates to a process for assembling two substrates by adhesive bonding, involving:
the coating, onto at least one of the two substrates to be assembled, of a composition obtained by mixing components A and B as defined above; and then
bringing the two substrates into effective contact;
crosslinking of the composition by subjecting it to electromagnetic irradiation.

Electromagnetic irradiation may be performed on the bonding wafers in the case of an opaque substrate, or directly through the substrate in the case of a transparent substrate.

The crosslinking step may be performed at a temperature of between 0° C. and 200° C., preferably between 10° C. and 150° C., preferably between 23 and 80° C. and in particular between 20° C. and 25° C.

The appropriate substrates are, for example, inorganic substrates, such as concrete, metals or alloys (such as aluminum alloys, steel, non-ferrous metals and galvanized metals); or else organic substrates, such as wood, plastics such as PVC, polycarbonate, PMMA, polyethylene, polypropylene, polyesters, epoxy resins; substrates made of metal and composites coated with paint.

The crosslinking is performed under electromagnetic irradiation, for instance with a UV radiation source or an LED.

The crosslinking step under electromagnetic irradiation may be performed at a wavelength greater than 300 nm, preferably ranging from 360 nm to 680 nm, and even more preferentially from 360 nm to 420 nm.

The compositions according to the invention advantageously do not comprise any peroxide. The compositions according to the invention advantageously allow a good compromise between stability on storage and high reactivity.

The compositions according to the invention advantageously have, after crosslinking, good adhesive properties.

In addition, the surface of the crosslinked compositions advantageously dries rapidly and may be tack-free, thereby notably making it possible to increase the productivity of industrial processes.

All the embodiments described above may be combined with each other. In particular, the various abovementioned constituents of the composition, and notably the preferred embodiments of the composition, may be combined with each other.

In the context of the invention, the term “between x and y” or “ranging from x to y” means a range in which the limits x and y are included. For example, the range “between 0% and 25%” notably includes the values 0% and 25%.

The invention is now described in the following implementation examples, which are given purely by way of illustration and should not be interpreted in order to limit the scope thereof.

### EXAMPLES

The following ingredients were used:
SR® 531: cyclic trimethylolpropane formal acrylate (CAS: 66492-51-1) sold by Arkema;
Speedcure® 939: (4-isopropylphenyl)(4-methylphenyl)iodonium tetrakis(pentafluoro-phenyl)borate (CAS: 178233-72-2) sold by Lambson;
Speedcure@ TPO-L (CAS: 84434-11-7) sold by Lambson: ethyl (2,4,6-trimethylbenzoyl)phenyl phosphinate;
Vanax® 808 HP: 3,5-diethyl-1,2-dihydro-1-phenyl-2-propylpyridine (CAS: 34562-31-7) sold by Vertellus Specialties;
Difluoroacetic acid (CAS: 381-73-7) available from Sigma-Aldrich.

### Example 1: Preparation of Composition 1 With a Photoinitiator

The ingredients of component A are mixed in the proportions shown in the following table, at a temperature of 23° C., in a continuously stirred mixer and under nitrogen.

The various ingredients constituting component B are mixed in the proportions shown in the following table, at a temperature of 23° C., in a continuously stirred mixer and under nitrogen.

Composition 1 according to the invention

| Component A | | Component B | |
|---|---|---|---|
| | % by weight | | % by weight |
| | (relative | | (relative |
| | to the | | to the |
| | total weight | | total weight |
| Ingredients | of A) | Ingredients | of B) |
| Trimethylolpropane | 96 | Trimethylolpropane | 99 |
| formal acrylate | | formal acrylate | |
| (SR ® 531) | | (SR ® 531) | |
| Speedcure ® 939 | 2 | Vanax ® 808 HP | 1 |
| Difluoroacetic acid | 1 | | |
| Speedcure ® TPO L | 1 | | |
| TOTAL | 100 | TOTAL | 100 |

Component A and component B are mixed in a 1:1 volume ratio, using a Sulzer@ Mixpac mixer at an ambient temperature of 23° C. The mixture is then irradiated at 405 nm with an intensity of 110 mW/cm² and its reactivity evaluated in air by pyrometry.

### Comparative Example 2: Preparation of Composition 2 Without Photoinitiator

The ingredients of component A are mixed in the proportions shown in the following table, at a temperature of 23° C., in a continuously stirred mixer and under nitrogen.

The various ingredients constituting component B are mixed in the proportions shown in the following table, at a temperature of 23° C., in a continuously stirred mixer and under nitrogen.

Comparative composition 2

| Component A | | Component B | |
|---|---|---|---|
| | % by weight | | % by weight |
| | (relative | | (relative |
| | to the | | to the |
| | total weight | | total weight |
| Ingredients | of A) | Ingredients | of B) |
| Trimethylolpropane | 97 | Trimethylolpropane | 99 |
| formal acrylate | | formal acrylate | |
| (SR ® 531) | | (SR ® 531) | |
| Speedcure ® 939 | 2 | Vanax ® 808 HP | 1 |
| Difluoroacetic acid | 1 | | |
| TOTAL | 100 | TOTAL | 100 |

Component A and component B are mixed in a 1:1 volume ratio, using a Sulzer® Mixpac mixer at an ambient temperature of 23° C. and its reactivity is evaluated in air by pyrometry.

### Example 3: Performance of the Compositions

The exotherm is analyzed continuously using a pyrometer and by thermal imaging, and also using an RT-FTIR spectrometer. The gel time (or lag time) is the time it takes for the sample to start polymerizing.

The time/temperature profiles were produced using an Omega OS552-V1-6 industrial infrared thermometer (Omega Engineering®, Inc., Stamford, CT) accurate to ±1° C. for 2 g (about 4.0 mm height) and 0.25 g (1.4 mm height) of polymerization.

| | | Temperature | |
|---|---|---|---|
| | Gel | peak | |
| Composition | time (s) | (in ° C.) | Comments |
| Composition 1 | 3 min 40 sec | 140° C. | No residual tack |
| (Example 1) | | | |
| Composition 2 | 7 min 40 sec | 120° C. | Residual tack |
| (comparative example 2) | | | |

Composition 1 polymerizes advantageously quickly (after mixing components A and B), given its short gel time (3 min 40 sec) relative to comparative composition 2, which comprises no photoinitiator (7 min 40 sec).

Finally, it was observed that the polymer obtained after crosslinking is advantageously surface dry (no tack) for composition 1 relative to composition 2 (residual tack).

1-17. (canceled)

18. A crosslinkable two-component composition comprising:
a component A comprising:
an iodonium salt having one of the formulae (I-A), (I-B) or (I-C) below: 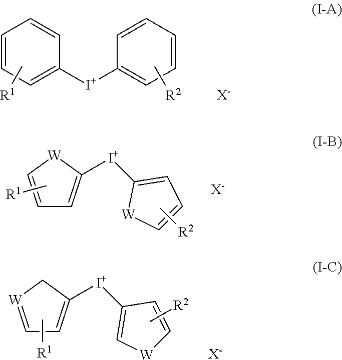
in which:
R¹ and R² each represent, independently of each other, a hydrogen atom, an alkyl radical, an alkenyl radical, a cycloalkyl radical, a cycloalkenyl radical, an aryl radical, a chlorine atom, a bromine atom, an iodine atom, a carboxylic radical, or an —NO₂ radical;
X⁻ represents a monovalent anion; and
W represents O or S;
at least one (meth)acrylate monomer M1;
an organic or mineral acid having a pKa or pKa1 ranging from 0.3 to 5 measured in water at 25° C.; and
at least one photoinitiator P1;
a component B comprising at least one dihydropyridine compound having one of the formulae (III) to (VII) below: 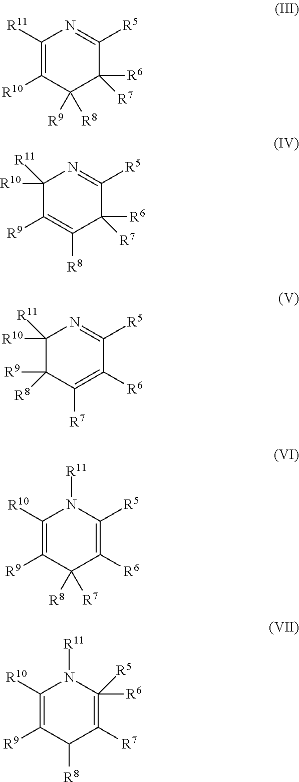
in which:
each of the radicals R⁵ to R¹¹ represents, independently of each other, a hydrogen, an alkyl, an alkenyl, an alkynyl, a cycloalkyl, a heterocycloalkyl, a heteroaryl, an aryl, an alkylaryl, an arylalkyl, a radical —COOR^{a};
said alkyl, alkenyl, alkynyl, cycloalkyl, heterocycloalkyl, heteroalkyl, aryl, alkylaryl and arylalkyl groups being optionally substituted;
and Ra represents an alkyl or aryl radical; or
two radicals from among R⁵ to R¹¹ together form an optionally substituted monocyclic or polycyclic ring.

19. The composition as claimed in claim 18, characterized in that, in formula (I-A) or (I-B) or (I-C), X⁻ represents F⁻, Cl⁻, Br⁻, I⁻, NO₃⁻, HSO₄⁻, H₂PO₄⁻, HCOO⁻, CH₃COO⁻, BF₄⁻, AsF₆⁻, PF₆⁻, CH₃—Ph—SO₃⁻; (F₅Ph)₄B⁻ or SbF₆⁻, X⁻.

20. The composition as claimed in claim 18, characterized in that the iodonium salt of formula (I-A) or (I-B) or (I-C) is chosen from diphenyliodonium hexafluorophosphate, diphenyliodonium fluoroborate, diphenyliodonium 2-carboxylate, bis(4-tert-butylphenyl)iodonium hexafluorophosphate, 3,3′ -dimethyldiphenyliodonium hexafluorophosphate and (4-isopropylphenyl)(4-methylphenyl)iodonium tetrakis(pentafluorophenyl)borate.

21. The composition as claimed in claim 18, characterized in that the (meth)acrylate monomer M1 has the formula (II) below: 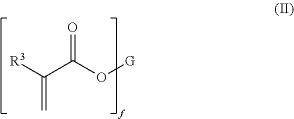
in which R³ represents H or methyl, G represents an organic radical, and f represents an integer from 1 to 4.

22. The composition as claimed in claim 18, characterized in that the (meth)acrylate monomer M1 is chosen from the group consisting of:
compounds having the formula (II-1) below: 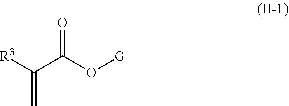
in which:
R³ represents H or methyl;
G is chosen from the group consisting of alkyls, cycloalkyls, alkenyls, cycloalkenyls, alkylaryls, arylalkyls or aryls, said alkyls, cycloalkyls, alkenyls, cycloalkenyls, alkylaryls, arylalkyls or aryls possibly being optionally substituted with and/or interrupted with at least one silane, silicone, oxygen, halogen, carbonyl, hydroxyl, ester, urea, urethane, carbonate, amine, amide, sulfur, sulfonate or sulfone;
polyethylene glycol di(meth)acrylates;
hexanediol di(meth)acrylate;
trimethylolpropane tri(meth)acrylate;
diethylene glycol di(meth)acrylate;
triethylene glycol di(meth)acrylate;
tetraethylene glycol di(meth)acrylate;
dipropylene glycol di(meth)acrylate;
di(pentamethylene glycol) di(meth)acrylate;
diglycerol tetra(meth)acrylate;
tetramethylene di(meth)acrylate;
ethylene di(meth)acrylate;
bisphenol A mono- and di(meth)acrylates;
bisphenol F mono- and di(meth)acrylates;
compounds of formula (VIII), (IX) or (X) below 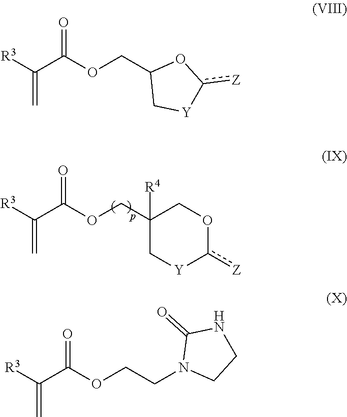
in which:
R³ represents H or methyl;
R⁴ represents H, methyl or ethyl;
represents 0 or 1; and
Z represents H, O, S, an alkyl group, a benzyl group, an aryl group or an alkoxy group;
Y represents O, S, NH or CH₂; [symbol]
is a single bond or a double bond, on condition that when Z represents O, then the bond [symbol] is a double bond;
and mixtures thereof.

23. The composition as claimed in claim 18, characterized in that G is an organic radical comprising at least one oxygen atom, said radical G being a polar aprotic radical.

24. The composition as claimed in claim 18, characterized in that the monomer M1 is chosen from the following compounds:

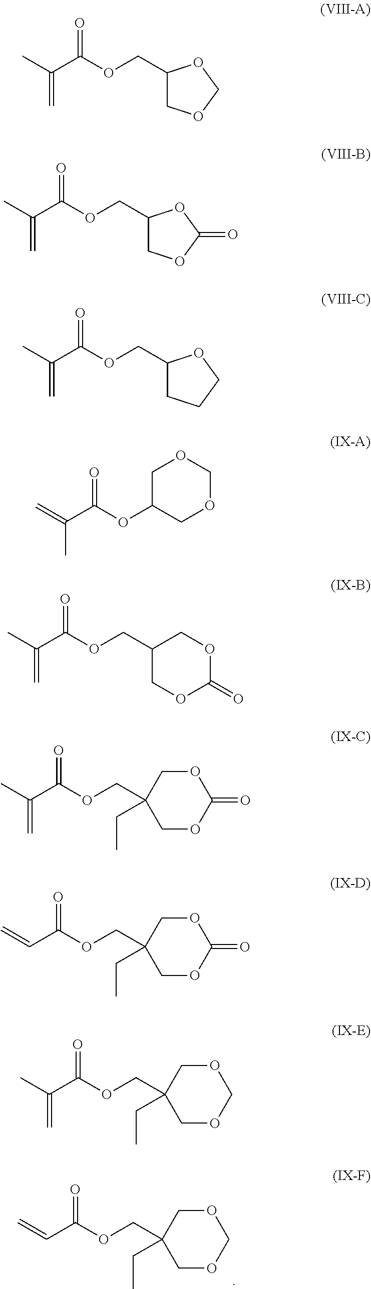

25. The composition as claimed in claim 18, characterized in that the content of (meth)acrylate monomer(s) M1 in the crosslinkable two-component composition ranges from 30% to 99% by weight relative to the total weight of said crosslinkable two-component composition.

26. The composition as claimed in claim 18, characterized in that the photoinitiator P1 is chosen from the group consisting of:
type I photoinitiators chosen from:
the family of acetophenones and alkoxyacetophenones;
the family of hydroxyacetophenones;
the family of alkylaminoacetophenones;
the family of benzoin ethers;
the family of phosphine oxides;
the family of metallocenes;
type II photoinitiators chosen from:
the family of benzophenones;
the family of thioxanthones;
the family of benzoylformate esters;
the family of dibenzylidene ketones;
the family of coumarins;
photoinitiators of the family of dyes;
and mixtures thereof.

27. The composition as claimed in claim 18, characterized in that the photoinitiator P1 is chosen from:
the family of phosphine oxides;
the family of thioxanthones.

28. The composition as claimed in claim 18, characterized in that the total content of photoinitiator(s) P1 may range from 0.1% to 5% by weight relative to the total weight of the crosslinkable two-component composition according to the invention.

29. The composition as claimed in claim 18, characterized in that the dihydropyridine compound has the formula (VI) or (VII) as defined in claim 18.

30. The composition as claimed in claim 18, characterized in that the dihydropyridine compound is chosen from the following compounds:

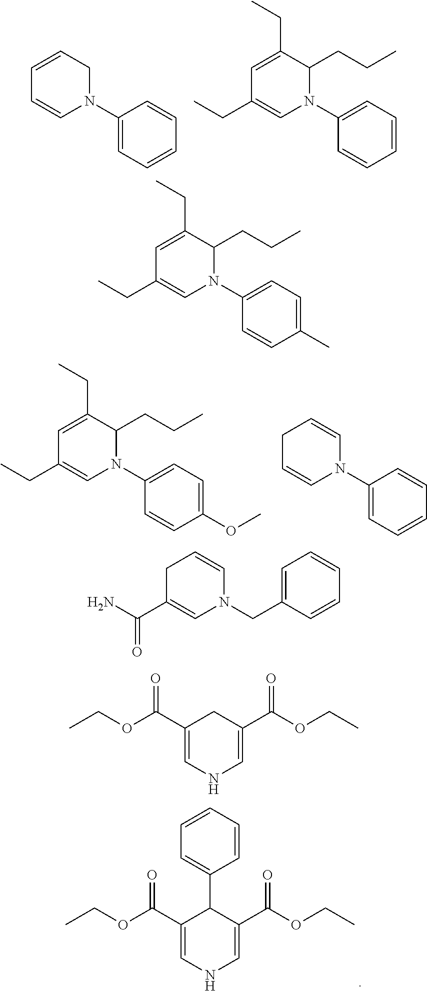

31. The composition as claimed in claim 18, characterized in that the mole ratio of dihydropyridine compound(s) of formulae (III) to (VII)/iodonium salt(s) of formula (I-A) or (I-B) or (I-C) ranges from 0.70 to 9.

32. The composition as claimed in claim 18, characterized in that the acid having a pKa or pka1 ranging from 0.3 to 5 is an organic acid chosen from carboxylic acids.

33. An adhesive, mastic or coating comprising the composition as defined in claim 18.

34. A process for assembling two substrates by adhesive bonding, comprising:
the coating, onto at least one of the two substrates to be assembled, of a composition obtained by mixing components A and B as defined in claim 18; and then
bringing the two substrates into effective contact; and
crosslinking of the composition by means of electromagnetic irradiation.
